(19) United States
(12) Patent Application Publication
(10) Pub. No.: US 2025/0377576 A1
(43) Pub. Date: Dec. 11, 2025

(54) REFLECTIVE MODULE AND CAMERA MODULE INCLUDING THE SAME

(71) Applicant: Samsung Electro-Mechanics Co., Ltd., Suwon-si (KR)

(72) Inventors: Young Hwan KWON, Suwon-si (KR); Min Jeong KANG, Suwon-si (KR); Do Seop HWANG, Suwon-si (KR); Po Chul KIM, Suwon-si (KR)

(73) Assignee: Samsung Electro-Mechanics Co., Ltd., Suwon-si (KR)

(21) Appl. No.: 19/086,781

(22) Filed: Mar. 21, 2025

(30) Foreign Application Priority Data
Jun. 5, 2024 (KR) 10-2024-0073891
Oct. 11, 2024 (KR) 10-2024-0138443

(51) Int. Cl. G03B 5/00; G03B 17/17

(52) U.S. Cl. CPC G03B 5/00; G03B 17/17; G03B 2205/0023; G03B 2205/0069

(57) ABSTRACT

A reflective module is provided. The reflective module includes a housing, a reflective member configured to rotate about a first axis in the housing, a driving unit configured to rotate the reflective member based on the first axis, and a pair of magnetic members arranged to face each other in a direction between the housing and the reflective member, wherein the driving unit includes a driving magnet and a driving coil that face each other in a direction, different from the direction in which the pair of magnetic members face each other, and wherein the first axis passes through the reflective member.

### CROSS-REFERENCE TO RELATED APPLICATIONS

This application claims the benefit under 35 USC § 119 (a) of Korean Patent Application Nos. 10-2024-0073891 filed on Jun. 5, 2024, and 10-2024-0138443 filed on Oct. 11, 2024, in the Korean Intellectual Property Office, the entire disclosures of which are incorporated herein by reference for all purposes.

### BACKGROUND

### 1. Field

The following disclosure relates to a reflective module and a camera module including the reflective module.

### 2. Description of Related Art

Camera modules implemented in mobile devices have been manufactured to have performance comparable to that of typical cameras.

For example, a camera module implemented in a mobile device may include a reflective member. Since the reflective member bends a path of light, the light path may be sufficiently increased without increasing the thickness of the mobile device, thereby improving the performance of the camera module.

The reflective member may be provided to be rotatable when optical image stabilization (OIS) is performed on the camera module, while being mounted on another component. In an example, the camera module may include a ball bearing that supports a rotation of the reflective member. The ball bearing acts like a wheel and may help movement of the reflective member with a relatively small force. However, depending on the position where the ball bearing is installed, the ball bearing may be significantly affected by a force that hinders driving, which may rather hinder smooth driving.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a reflective module includes a housing; a reflective member configured to rotate about a first axis in the housing; a driving unit configured to rotate the reflective member based on the first axis; and a pair of magnetic members disposed to face each other in a direction between the housing and the reflective member, wherein the driving unit comprises a driving magnet and a driving coil that face each other in a direction, different from the direction in which the pair of magnetic members face each other, and wherein the first axis passes through the reflective member.

The pair of magnetic members may face each other in a direction, parallel to the first axis, and the driving magnet and the driving coil may face each other in a second axis direction, perpendicular to the first axis.

The reflective module may further include a reflective holder on which the reflective member is disposed; and a carrier on which the reflective holder is supported; wherein the carrier configured to rotate about the first axis together with the reflective member and the reflective holder, while being disposed in the housing.

The driving magnet and one of the pair of magnetic members may be respectively disposed on different sides of the carrier.

The reflective module may further include a sensing magnet disposed in the carrier in parallel with the driving magnet; and a position sensor disposed in the housing to face the sensing magnet.

A plurality of ball members may be disposed between the housing and the carrier, the plurality of ball members may include a pivot ball through which the first axis passes and a plurality of guide balls that are spaced apart from the pivot ball, and a shortest distance between the pivot ball and the guide ball may be less than a shortest distance between the pivot ball and the driving magnet.

The plurality of guide balls may include two ball members, and an angle between the two ball members based on the pivot ball is an acute angle.

The magnetic member disposed on the carrier, among the pair of magnetic members, may be disposed inside a support region that is formed by connecting the plurality of ball members.

The reflective holder may be rotated based on a second axis, perpendicular to the first axis, together with the reflective member.

A buffer member may be disposed to protrude in a direction, parallel to the first axis, toward the carrier in the housing, and the buffer member may be spaced apart from a pivot ball of a plurality of ball members in a direction of a second axis, perpendicular to the first axis, with the first axis interposed therebetween.

In a general aspect, a reflective module includes a housing having an internal space; a reflective member disposed in the internal space; a carrier rotatably supported in the internal space; and three ball members disposed between the housing and the carrier, and configured to support a rotation of the carrier, wherein a triangle formed by connecting the three ball members is an acute triangle.

The reflective module may include a pair of magnetic members respectively disposed on a surface of the housing and a surface of the carrier which face each other with the three ball members interposed therebetween, and the pair of magnetic members are configured to generate a magnetic attraction, wherein the pair of magnetic members may be disposed so that a center of a magnetic attraction formed by the pair of magnetic members is located within the acute triangle.

The pair of magnetic members may include a pulling magnet disposed on the carrier; and a pulling yoke disposed in the housing to face the pulling magnet.

The three ball members may include a pivot ball through which a rotational axis of the carrier passes; and two guide balls spaced apart from the pivot ball, wherein the pulling magnet is disposed in a position at which a distance between a center of the pulling magnet and the pivot ball is less than a distance between the center of the pulling magnet and the two guide balls.

The center of the pulling magnet may be spaced apart from the pivot ball in a direction perpendicular to the rotational axis of the carrier.

A camera module may include the reflective module and a lens module including a plurality of lenses configured to refract light passing through the reflective module.

In a general aspect, a reflective module includes a housing having an internal space; a carrier disposed within the internal space; a reflective holder disposed on the carrier, and a reflective member mounted on the reflective holder, wherein the housing comprises a buffer member that protrudes toward the carrier, and wherein the carrier includes an accommodating portion configured to accommodate the buffer member.

The carrier may be rotated about a first axis with respect to the housing, and the reflective holder may be rotated about a second axis, perpendicular to the first axis, with respect to the carrier and the housing.

The reflective module may further include a pivot ball through which the first axis passes and a plurality of guide balls spaced apart from the pivot ball, wherein the pivot ball and the plurality of guide balls may be arranged between the carrier and the housing.

The buffer member may be provided in plural, and the plurality of buffer members may be spaced apart from each other with the pivot ball disposed therebetween.

The pivot ball and the plurality of buffer members may be arranged in a direction parallel to the second axis.

The buffer member may be spaced apart from the reflective holder in a direction parallel to the first axis.

The reflective module may further include a support frame that is at least partially disposed inside the housing, wherein the buffer member may be disposed on the support frame.

The reflective module may further include a first driving unit comprising a first driving magnet and a first driving coil and configured to generate a driving force to rotate the carrier about the first axis; and a pair of magnetic members respectively disposed on the carrier and the housing and configured to generate a magnetic force to press the carrier against the housing, wherein a direction in which the first driving magnet and the first driving coil face each other, and a direction in which the pair of magnetic members face each other are perpendicular to each other.

The first driving magnet and the first driving coil may face each other in a direction parallel to the second axis, and the pair of magnetic members may face each other in a direction parallel to the first axis.

A camera module may include the reflective module and a lens module including a plurality of lenses configured to refract light passing through the reflective module.

Other features and aspects will be apparent from the following detailed description, the drawings, and the claims.

### BRIEF DESCRIPTION OF DRAWINGS

FIG. 1 is a perspective view of an example camera module, in accordance with one or more embodiments.

FIG. 2 is an internal perspective view of an example camera module, in accordance with one or more embodiments.

FIG. 3 is a schematic exploded perspective view of an example camera module, in accordance with one or more embodiments.

FIG. 4A is a cross-sectional view taken along line I-l′ of FIG. 1.

FIG. 4B is a cross-sectional view taken along line II-II′ of FIG. 1.

FIG. 5 is an exploded perspective view of an example camera module, in accordance with one or more embodiments.

FIG. 6 is a perspective view of a housing, in accordance with one or more embodiments.

FIG. 7 is a perspective view of a main substrate, in accordance with one or more embodiments.

FIG. 8 is a perspective view illustrating a main substrate coupled to a housing, in accordance with one or more embodiments.

FIG. 9 is a perspective view of a reflective module, in accordance with one or more embodiments.

FIG. 10A is an exploded perspective view of a reflective module, in accordance with one or more embodiments.

FIG. 10B is an exploded perspective view of a reflective module viewed from a different angle from FIG. 10A.

FIG. 11 is a cross-sectional view taken along line III-III′ of FIG. 9.

FIG. 12 is a bottom perspective view of a reflective module, in accordance with one or more embodiments.

FIG. 13 is a bottom view of a reflective module (carrier), in accordance with one or more embodiments.

FIG. 14 is an exploded perspective view of a housing and a carrier, in accordance with one or more embodiments.

FIG. 15 is a cross-sectional view taken along line IV-IV′ of FIG. 9.

FIG. 16 is an exploded perspective view of an example lens module, in accordance with one or more embodiments.

FIG. 17 is a bottom exploded perspective view of an example lens module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The one or more examples relate to a reflective module and a camera module including the same and may be applied to portable electronic devices, such as, but not limited to, smartphones and tablet personal computers (PCs).

One or more example may provide a reflective module with improved operation stability and a camera module including the same. Specifically, an aspect of the one or more examples may provide a reflective module having a structure in which the intensity of a driving force is increased and a load that interferes with the driving is minimized, and a camera module including the same.

One or more examples may also provide a reflective module that may alleviate damage due to impacts from collisions and a camera module including the same.

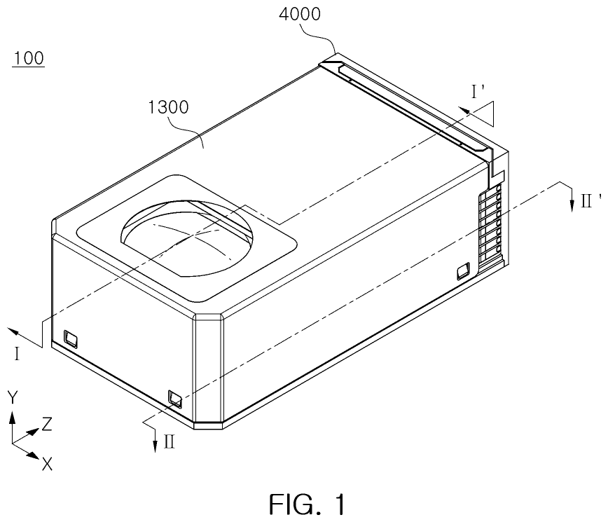

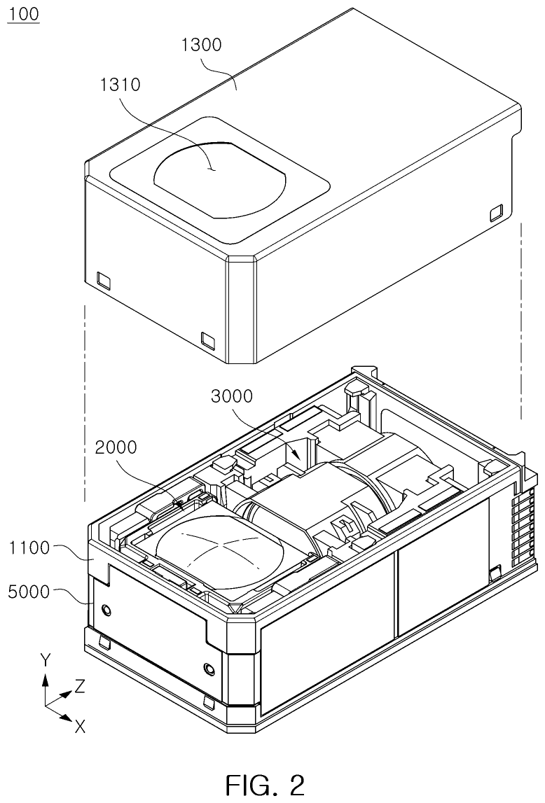

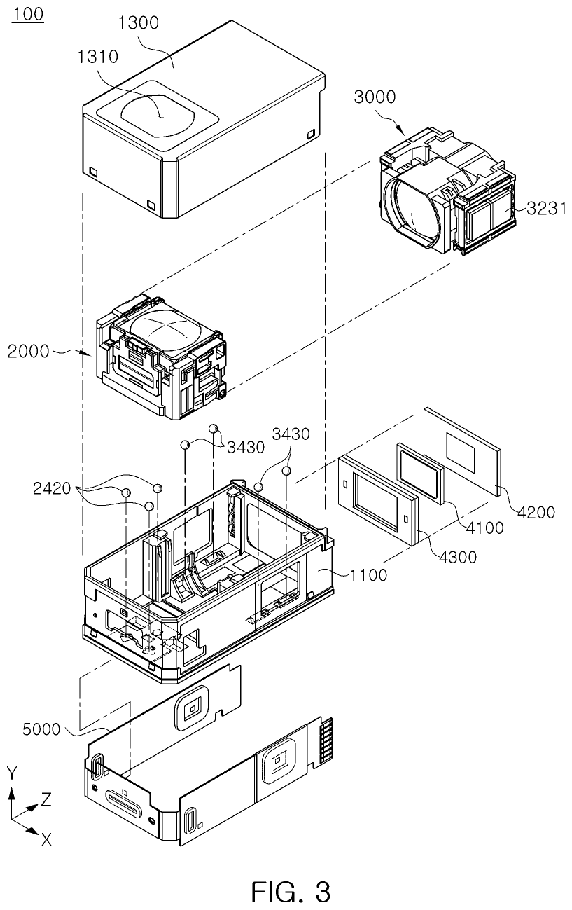

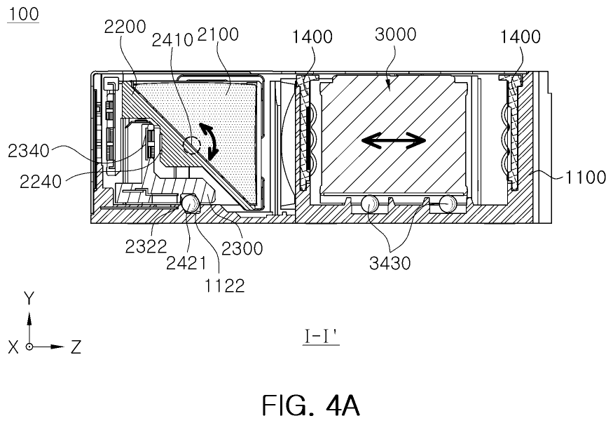

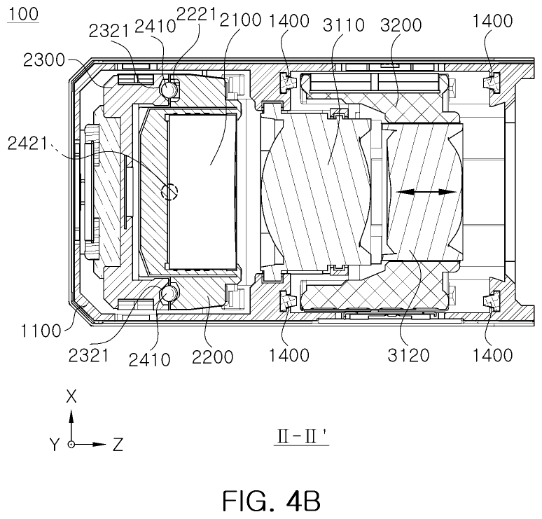

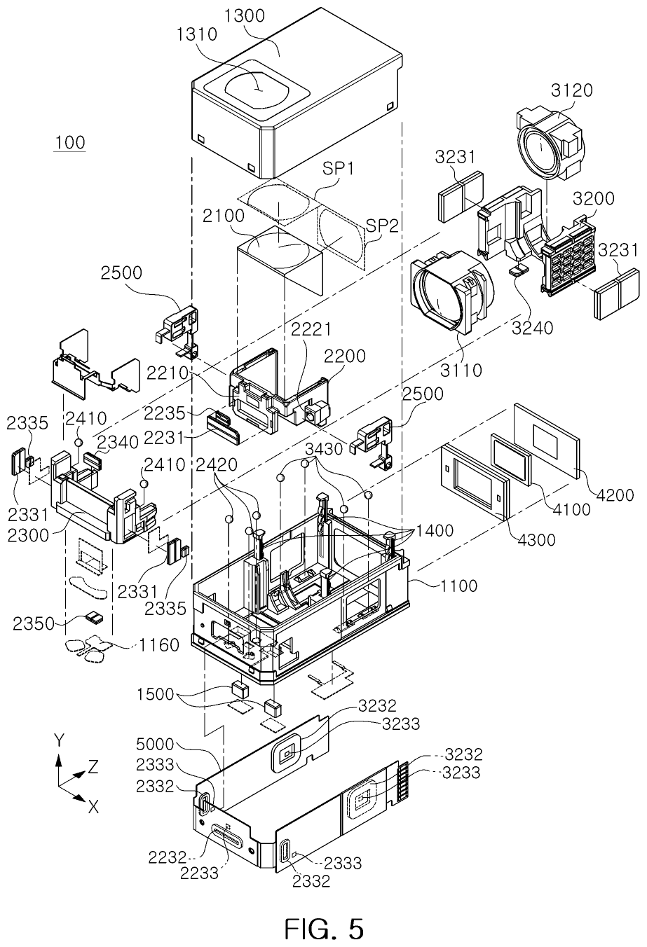

FIG. 1 is a perspective view of an example camera module, in accordance with one or more embodiments, FIG. 2 is an internal perspective view of an example camera module, in accordance with one or more embodiments, FIG. 3 is a schematic exploded perspective view of an example camera module, in accordance with one or more embodiments, FIG. 4A is a cross-sectional view taken along line I-l′ of FIG. 1, FIG. 4B is a cross-sectional view taken along line II-II′ of FIG. 1, and FIG. 5 is an exploded perspective view of an example camera module, in accordance with one or more embodiments.

A camera module 100, in accordance with one or more embodiments, may include a reflective module 2000, a lens module 3000, and an image sensor module 4000, and a housing 1100 and a case 1300 accommodating the above components.

The reflective module 2000 may be configured to change a traveling direction of incident light, incident on the camera module 100. Accordingly, the reflective module 2000 may include a reflective member 2100 that reflects incident light.

Referring to FIG. 2 and FIG. 4A, the reflective member 2100 of the reflective module 2000 may reflect incident light incident in a thickness direction (a Y-axis direction) of the camera module 100 to a length direction (a Z-axis direction) of the camera module 100.

The lens module 3000 may include a plurality of lenses that refract incident light passing through the reflective module 2000. The plurality of lenses may be provided in the length direction (hereinafter, an optical axis direction) (the Z-axis direction) of the camera module 100.

Referring to FIG. 3, the image sensor module 4000 may include an image sensor 4100 and a printed circuit board (hereinafter, sensor substrate) 4200 on which the image sensor 4100 is mounted.

Incident light passing through the lens module 3000 may be incident on the image sensor 4100, and the image sensor 4100 may convert the incident light into an electric signal.

One or more baffles (not shown) may be provided between the lens module 3000 and the image sensor 4100 to reduce a flare phenomenon. The baffles may be arranged in an internal space of the housing 1100 described below.

Additionally, the image sensor module 4000 may further include an optical filter 4300 that filters light passing through the lens module 3000 and incident on the image sensor 4100. In an example, the optical filter 4300 may be an infrared cut filter.

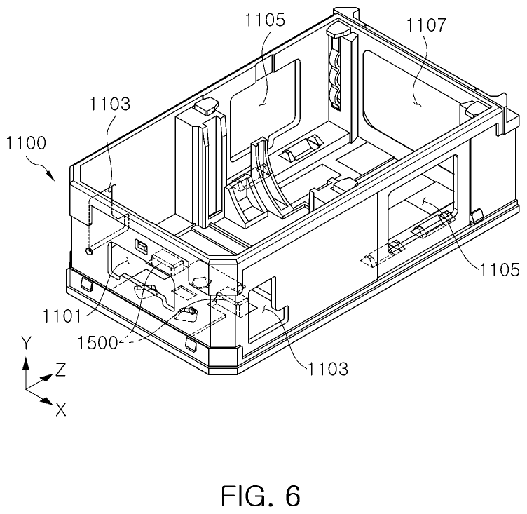

FIG. 6 is a perspective view of the housing, in accordance with one or more embodiments.

Referring to FIG. 6, the housing 1100 may have an internal space. In the internal space of the housing 1100, the reflective module 2000 and the lens module 3000 may be sequentially arranged in the traveling direction of incident light.

The image sensor module 4000 may be disposed at the rear of the lens module 3000. The image sensor module 4000 may be coupled to an outer surface of the housing 1100 so that an imaging plane of the image sensor 4100 is exposed to an internal space of the housing 1100.

In this manner, when the reflective module 2000 and the lens module 3000 are arranged in the single housing 1100, the number of parts may be reduced, so that the assembly may be facilitated and the optical axes of the reflective module 2000 and the lens module 3000 do not need to be aligned separately.

However, this is only an example, and unlike those illustrated in the drawing, the reflective module 2000 and the lens module 3000 may be accommodated in housings, respectively. The housings in which the reflective module 2000 and the lens module 300 are accommodated, respectively, may be connected to each other.

According to an embodiment, a printed circuit board (hereinafter, referred to as a main substrate) 5000 on which a driving coil or the like is mounted may be arranged on an outer surface of the housing 1100.

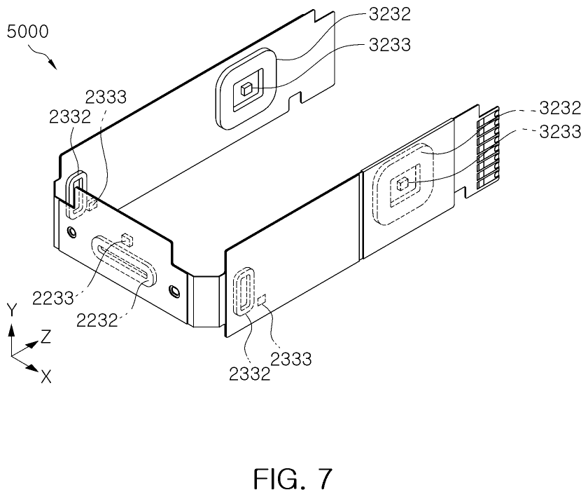

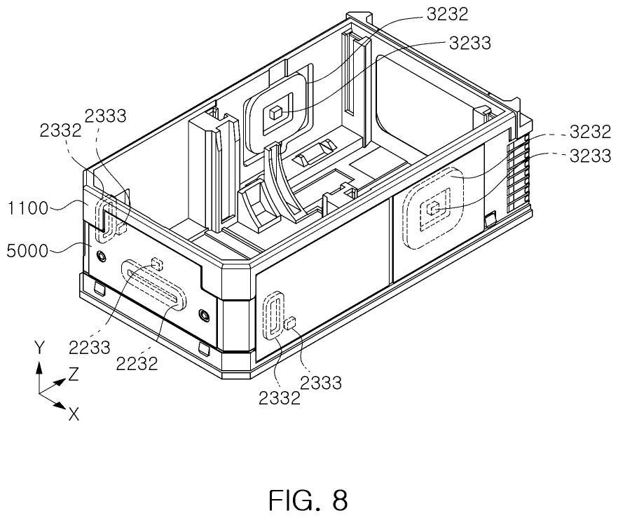

FIG. 7 is a perspective view of the main substrate, in accordance with one or more embodiments, and FIG. 8 is a perspective view illustrating the main substrate coupled to the housing, in accordance with one or more embodiments.

According to an embodiment, the main substrate 5000 may be bent in some portions to be arranged on multiple surfaces of the housing 1100. For example, the main substrate 5000 may be disposed to cover side surfaces of the housing 1100.

In an example, referring to FIG. 6, the housing 1100 may include through-holes 1101, 1103, 1105, and 1107, and the driving coil mounted on the main substrate 5000 and the image sensor 4100 may be exposed to the internal space of the housing 1100 through the through-holes 1101, 1103, 1105, and 1107.

The case 1300 may be coupled to the housing 1100 to cover the open upper portion of the housing 1100. In an embodiment, the case 1300 may include a metal material to operate as a shield can.

Referring to FIG. 2, the case 1300 may include an opening 1310 through which light passes. Light may be incident on the reflective module 2000 through the opening 1310.

The camera module 100, in accordance with one or more embodiments, may basically have an optical image stabilization (OIS) operation and an autofocusing (AF) operation.

In an embodiment, in order to compensate for a shake, for example, a handshake, the reflective module 2000 may be provided to be rotatable about two axes (the X-axis and the Y-axis). Additionally, in order to adjust the focus, the lens module 3000 may be provided to be movable in the optical axis direction (the Z-axis direction).

Accordingly, the reflective module 2000 and the lens module 3000 may be arranged in the housing 1100 via a ball member. Movement of the reflective module 2000 and the lens module 3000 may be a relative movement with respect to the housing 1100.

In an example, the camera module 100, in accordance with one or more embodiments, may also have a zoom operation. The zoom operation may be implemented by movement of the lens module 3000 in the optical axis direction (the Z-axis direction), and to this end, the lens module 3000 may include a plurality of independently driveable lens barrels.

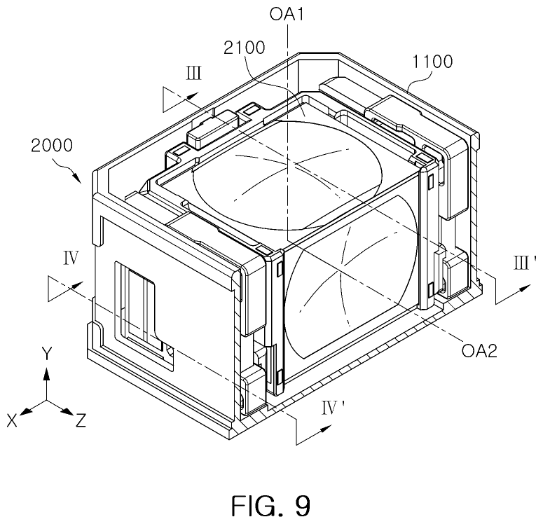

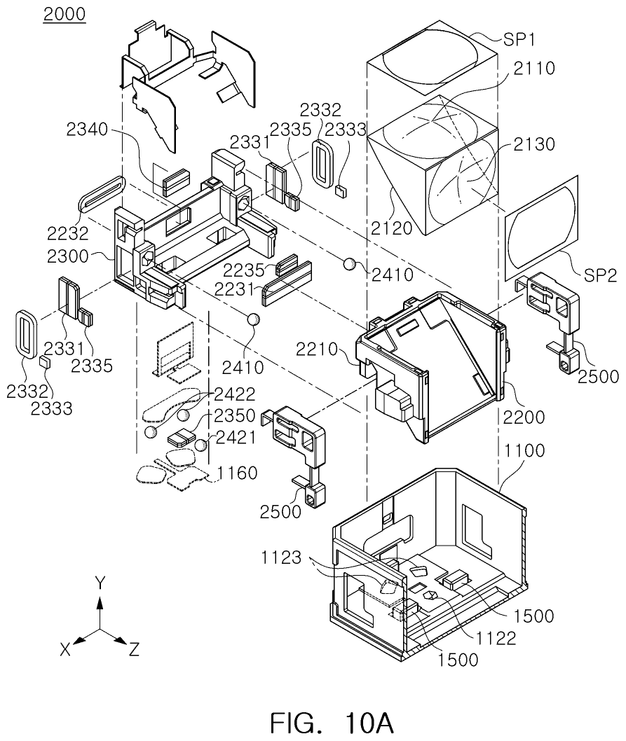

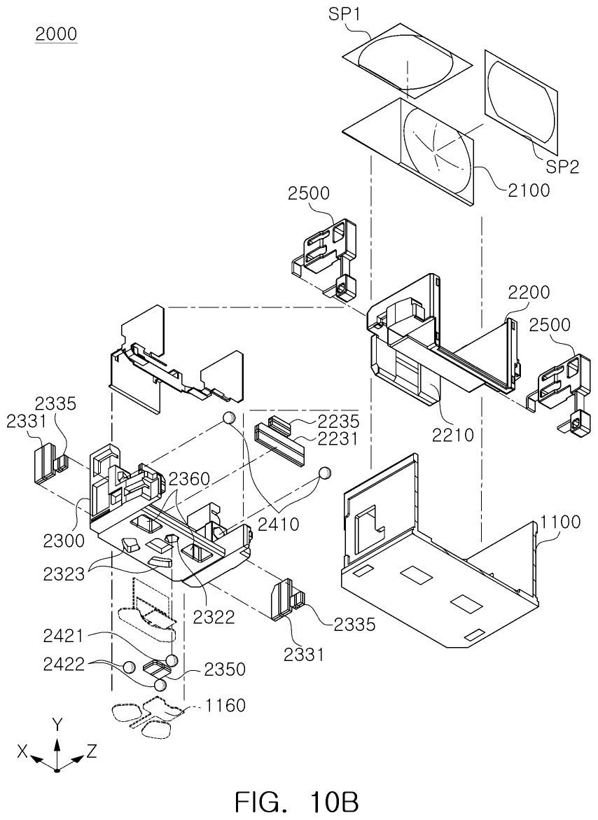

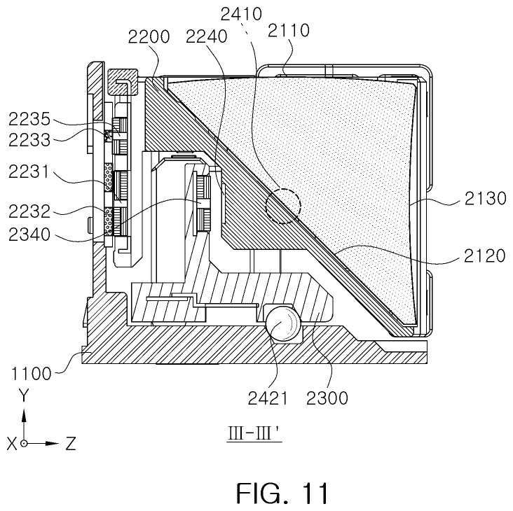

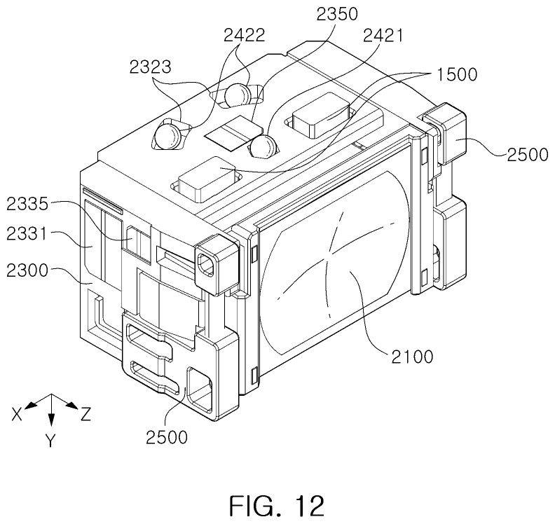

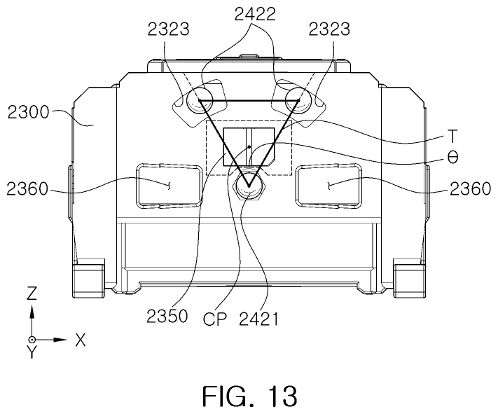

FIG. 9 is a perspective view of a reflective module 2000, in accordance with one or more embodiments, FIG. 10A is an exploded perspective view of a reflective module 2000, in accordance with one or more embodiments, FIG. 10B is an exploded perspective view of a reflective module 2000 viewed from a different angle from FIG. 10A, FIG. 11 is a cross-sectional view taken along line III-III′ of FIG. 9, FIG. 12 is a bottom perspective view of a reflective module 2000, in accordance with one or more embodiments, and FIG. 13 is a bottom view of a reflective module (carrier), in accordance with one or more embodiments.

According to an embodiment, the reflective module 2000 may include a reflective holder 2200 on which the reflective member 2100 is disposed and a carrier 2300 on which the reflective holder 2200 is supported. The carrier 2300 may be rotatably supported by a housing 1100, while rotatably supporting the reflective holder 2200.

According to an embodiment, the reflective member 2100 may be provided as a prism including an incident surface 2110, a reflective surface 2120, and an exit surface 2130. However, this is only an example, and, in an example, the reflective member 2100 may be provided as a mirror.

When a direction in which incident light is incident is defined as a first optical axis OA1 direction, which is parallel to a thickness direction (the Y-axis direction) of the camera module 100, the first optical axis OA1 may pass through the center of the incident surface 2110. Additionally, when the optical axis direction (the Z-axis direction) of the camera module 100 is defined as a second optical axis OA2 direction, the second optical axis OA2 may pass through the center of the exit surface 2130.

The reflective surface 2120 may be disposed obliquely with respect to the incident surface 2110 and the exit surface 2130. In an example, the first optical axis OA1 and the second optical axis OA2 may intersect at approximately the center of the reflective surface 2120. The reflective surface 2120 may change the traveling direction of incident light incident in the first optical axis OA1 direction to the second optical axis OA2 direction.

In a non-limited example, the incident surface 2110 and the exit surface 2130 of the reflective member 2100 may have curvatures. Referring to FIG. 11, the incident surface 2110 may have a convex shape, and the exit surface 2130 may have a concave shape. However, the shapes of the incident surface 2110 and the exit surface 2130 are not limited to the above shapes.

Since the incident surface 2110 and the exit surface 2130 may have curvatures, the reflective member 2100 may operate as a lens. Therefore, when the incident surface 2110 and the exit surface 2130 of the reflective member 2100 have curvatures, some lenses may be omitted from the lens module 3000, and thus, the size of the camera module 100 may be reduced.

Referring to FIG. 10A or the like, spacers SP1 and SP2 may be provided on an object side of the incident surface 2110 and an image side of the exit surface 2130, respectively. For example, the spacers SP1 and SP2 may be disposed among the reflective member 2100, the case 1300, and the housing 1100.

The spacers SP1 and SP2 may include an opening through which incident light passes, and a light blocking portion provided along the periphery of the opening. The light blocking portion may be a black-coated portion and may cover the periphery of an effective region of the incident surface 2110 and the exit surface 2130 to block light passing through the corresponding region.

According to an embodiment, the reflective module 2000 may be provided to rotate about two axes (the X-axis and the Y-axis) perpendicular to the optical axis (the Z-axis).

In an embodiment, the reflective holder 2200 may be rotated about a first axis (the X-axis) while being supported by the carrier 2300, and the carrier 2300 may be rotated about a second axis (the Y-axis) together with the reflective holder 2200, while being supported by the housing 1100. The first axis (the X-axis) and the second axis (the Y-axis) may be perpendicular to each other.

The reflective member 2100 provided in the reflective holder 2200 may be rotated together with the reflective holder 2200. Therefore, the reflective member 2100 may be rotated about the first axis (the X-axis) and the second axis (the Y-axis).

A first ball member 2410 may be disposed between the reflective holder 2200 and the carrier 2300 to support a rotation of the reflective holder 2200 with respect to the carrier 2300.

In an embodiment, the first ball member 2410 may include a plurality of ball members that are spaced apart from each other in the first axis (the X-axis) direction with the reflective member 2100 interposed therebetween.

The first ball member 2410 may form a first axis (the X-axis), while rotating in place while being fixed in position with respect to the reflective holder 2200 and the carrier 2300. The first axis (the X-axis) may pass through the first ball member 2410.

The reflective holder 2200 and the carrier 2300 may include accommodating recesses 2221 and 2231 to accommodate the first ball member 2410. Each of the accommodating recesses 2221 and 2231 may be provided spaced apart from each other in the first axis direction (the X-axis direction) and may be provided in a number corresponding to the number of first ball members 2410.

In an embodiment, the reflective holder 2200 may include a first accommodating recess 2221 to receive a portion of the first ball member 2410, and the carrier 2300 may include a second accommodating recess 2321 provided to face the first accommodating recess 2221 and accommodating another portion of the first ball member 2410. In an example, the first accommodating recess 2221 and the second accommodating recess 2321 may face each other in the optical axis direction (the Z-axis direction).

The first ball member 2410 may be supported at three or two points by the first accommodating recess 2221 and the second accommodating recess 2321. That is, the first accommodating recess 2221 and the second accommodating recess 2321 may include three or two inclined surfaces.

In an embodiment, the first accommodating recess 2221 and the second accommodating recess 2321 may include three inclined surfaces so that the first ball member 2410 may rotate in place. Also, the first accommodating recess 2221 or the second accommodating recess 2321 may include two inclined surfaces to overcome defects due to tolerance.

The reflective holder 2200 may be supported on the carrier 2300 by a magnetic force (magnetic attraction). Accordingly, a pair of magnetic members that generate a magnetic attraction may be arranged on the reflective holder 2200 and the carrier 2300.

Referring to FIG. 11, the pair of magnetic members may include a pulling magnet 2340 disposed in a carrier 2300 and a pulling yoke 2240 inserted in the reflective holder 2200.

The pair of magnetic members may generate a magnetic attraction in a direction in which they each other. For example, the pair of magnetic members may face each other in the optical axis direction (the Z-axis direction), and the magnetic attraction therebetween may be generated in the optical axis direction (the Z-axis direction). Accordingly, the reflective holder 2200 may be supported on the carrier 2300 in the optical axis direction (the Z-axis direction).

In an example, the direction in which the reflective holder 2200 is supported by the carrier 2300 may match the direction in which the reflective holder 2200 and the carrier 2300 face each other with the first ball member 2410 interposed therebetween. Therefore, the first ball member 2410 may support the rotation of the reflective holder 2200, without escaping from between the reflective holder 2200 and the carrier 2300.

The reflective module 2000 may include a first driving unit that provides a driving force to rotate the reflective holder 2200.

The first driving unit may include a first driving magnet 2231 and a first driving coil 2232 arranged to face each other. The reflective holder 2200 may be rotated about the first axis (the X-axis) by the electromagnetic interaction between the first driving magnet 2231 and the first driving coil 2232.

In an embodiment, the first driving magnet 2231 may be disposed in the reflective holder 2200, and the first driving coil 2232 may be disposed in the housing 1100. However, in another embodiment, the positions of the first driving magnet 2231 and the first driving coil 2232 may be interchanged.

The reflective holder 2200 may include an extension 2210 extending from the reflective holder 2200 and positioned between the carrier 2300 and the housing 1100, and the first driving magnet 2231 may be disposed on the extension 2210.

The first driving coil 2232 may be mounted on the main substrate 5000, and may be disposed on one surface of the housing 1100. The first driving coil 2232 may be exposed to the internal space of the housing 1100 through the through-hole (1101) formed in the housing 1100, and thus may directly face the first driving magnet 2231.

In an embodiment, the first driving magnet 2231 and the first driving coil 2232 may face each other in the optical axis direction (the Z-axis direction).

The first driving magnet 2231 may be magnetized in the second axis direction (the Y-axis direction), which is approximately a rotational direction of the reflective holder 2200. For example, one surface of the first driving magnet 2231 facing the first driving coil 2232 may include an N-pole (S-pole) region, a neutral region, and an S-pole (N-pole) region in the second axis direction (the Y-axis direction).

The first driving unit may further include a first yoke (not shown) that faces the first driving magnet 2231 with the first driving coil 2232 interposed therebetween.

The first yoke may be disposed on the other side, which is a surface opposite to the surface in which the first driving coil 2232 is disposed. In an example, the first yoke may be provided as a magnetic member and may focus the magnetic flux of the first driving magnet 2231.

Additionally, the first driving unit may include a first position sensing unit (or sensor) that detects the position of the reflective holder 2200. The first position sensing unit may include a first sensing magnet 2235 and a first position sensor 2233 arranged to face each other. In an example, the first position sensor 2233 may be provided as a Hall sensor, and may detect a change in magnetic flux to detect the amount of movement of the reflective holder 2200.

The first sensing magnet 2235 may be disposed on the extension 2210 of the reflective holder 2200 together with the first driving magnet 2231. The first sensing magnet 2235 may be disposed and spaced apart from the first driving magnet 2231 in the second-axis direction (the Y-axis direction).

Additionally, one surface of the first sensing magnet 2235 facing the first position sensor 2233 may include an N-pole (S-pole) region, a neutral region, and an S-pole (N-pole) region in the second-axis direction (the Y-axis direction).

In an embodiment, the first driving magnet 2231 and the first sensing magnet 2235 may be disposed so that the same polarity regions (N-pole and N-pole or S-pole and S-pole) are adjacent to each other.

The first position sensor 2233 may be disposed on the main substrate 5000. The first position sensor 2233 may be disposed to face the neutral region of the first sensing magnet 2235 when the reflective holder 2200 is in the neutral position.

According to an embodiment, since the first position sensor 2233 is spaced apart from the first driving coil 2232, the first position sensor 2233 may be less affected by the magnetic field of the first driving coil 2232, and thus, the sensing accuracy may be improved.

A second ball member 2420 may be disposed between the carrier 2300 and the housing 1100 to support the rotation of the carrier 2300 with respect to the housing 1100.

In an embodiment, the second ball member 2420 may include a single pivot ball 2421 and a guide ball 2422 spaced apart from the pivot ball 2421.

The pivot ball 2421 may form the second axis (the Y-axis) while rotating in place with a fixed position relative to the carrier 2300 and the housing 1100. The second axis (the Y-axis) may pass through the pivot ball 2421.

The carrier 2300 and the housing 1100 may include accommodating recesses 2322 and 1122 to accommodate the pivot ball 2421.

In an embodiment, the carrier 2300 may include a third accommodating recess 2322 that accommodates a portion of the pivot ball 2421, and the housing 1100 may include a fourth accommodating recess 1122 provided to face the third accommodating recess 2322 and accommodating another portion of the pivot ball 2421. For example, the third accommodating recess 2322 and the fourth accommodating recess 1122 may face each other in the second axis direction (the Y-axis direction).

The pivot ball 2421 may be supported at three points in the third accommodating recess 2322 and the fourth accommodating recess 1122. The third accommodating recess 2322 and the fourth accommodating recess 1122 may include three inclined surfaces so that the pivot ball 2421 may rotate in place.

The guide ball 2422 may be spaced apart from the second axis (the Y-axis), which is a rotational axis of the carrier 3300, and may support the rotation of the carrier 3300 with respect to the second axis (the Y-axis).

The guide ball 2422 may include two ball members spaced apart from each other approximately in the first axis direction (the X-axis direction).

The carrier 2300 and the housing 1100 may include guide recesses 2323 and 1123 that accommodate the guide balls 2422. The guide recesses 2323 and 1123 may be provided spaced apart in the first axis direction (the X-axis direction) and may be provided in a number corresponding to the number of guide balls 2422.

In an embodiment, the carrier 2300 may include a first guide recess 2323 that accommodates a portion of the guide ball 2422, and the housing 1100 may include a second guide recess 1123 provided to face the first accommodating recess 2323 and accommodates another portion of the guide ball 2422. For example, the first guide recess 2323 and the second guide recess 1123 may face each other in the second axis direction (the Y-axis direction).

The first guide recess 2323 and the second guide recess 1123 may extend approximately in the rotational direction of the carrier 2300. For example, the first guide recess 2323 and the second guide recess 1123 may extend (a curved shape) along an arc of a circle based on the second axis (the Y-axis) or may extend (straight shape) in a normal direction of the circle. Accordingly, the guide ball 2422 may guide the rotation of the carrier 2300 while being accommodated in the first guide recess 2323 and the second guide recess 1123.

In an embodiment, the first guide recess 2323 and the second guide recess 1123 may have a flat bottom surface, and the guide ball 2422 may contact the flat bottom surfaces of the first guide recess 2323 and the second guide recess 1123.

That is, the guide ball 2422 may roll on the bottom surfaces of the guide recesses 2323 and 1123 while being supported by one point on each of the first guide recess 2323 and the second guide recess 1123. In this example, since the guide recesses 2323 and 1123 do not restrain the side surface of the guide ball 2422, the rolling of the guide ball 2422 may be smooth.

According to an embodiment, the angle θ between the guide ball 2422 based on the pivot ball 2421 may be 90° or less, preferably, an acute angle. The angle θ may be defined as an angle that is formed by two lines connecting the centers of each of the guide balls 2422 and the center of the pivot ball 2421. The angle θ between the guide balls 2422 may be set within a rotation range (deg) according to the rotation range of the carrier 2300. The guide ball 2422 may change in position within the space defined by the guide recesses 2323 and 1123 as the carrier 2300 rotates, but the angle θ between the guide balls 2422 based on the pivot ball 2421 may constantly be an acute angle regardless of the position of the guide balls 2422.

The carrier 2300 may be supported by the housing 1100 by a magnetic force (magnetic attraction). Accordingly, a pair of magnetic members that generate a magnetic attraction may be arranged in the carrier 2300 and the housing 1100.

The pair of magnetic members may include a pulling magnet 2350 disposed in the carrier 2300 and a pulling yoke 1160 inserted in the housing 1100.

The pair of magnetic members may generate a magnetic attraction in a direction in which the pair of magnetic members face each other. For example, a pair of magnetic members may face each other in the second axis direction (the Y-axis direction), and a magnetic attraction therebetween may be generated in the second axis direction (the Y-axis direction). Therefore, the carrier 2300 may be supported in the housing 1100 in the second axis direction (the Y-axis direction).

In an example, the direction in which the carrier 2300 is supported in the housing 1100 may match a direction in which the carrier 2300 and the housing 1100 face each other with the second ball member 2420 interposed therebetween. Therefore, the second ball member 2420 may not escape from the carrier 2300 and the housing 1100 and may support the rotation of the carrier 2300.

According to an embodiment, the pulling magnet 2350 disposed on the carrier 2300 may be positioned within a support region T having a triangular shape approximately defined by the second ball member 2420. Similarly, the pulling yoke 1160 disposed on the housing 1100 to face the pulling magnet 2350 may also be positioned within the support region T approximately defined by the second ball member 2420.

Preferably, both the pulling magnet 2350 and the pulling yoke 1160 may be continuously positioned within the support region T defined by the second ball member 2420 (2421 and 2422), while the carrier 2300 rotates about the second axis (the Y-axis). However, this does not necessarily mean that the pulling magnet 2350 and the pulling yoke 1160 are wholly located within the support region T and may include an example in which a portion thereof is located within the support region T.

Referring to FIG. 13, in an embodiment, the center of magnetic attraction formed by the pulling magnet 2350 and the pulling yoke 1160 while the carrier 2300 rotates about the second axis (the Y-axis) may be located within the support region T. The center of magnetic attraction formed by the pulling magnet 2350 and the pulling yoke 1160 may approximately coincide with the geometric center CP of the pulling magnet 2350. Therefore, the center of magnetic attraction may constantly be located within the support region T while the carrier 2300 rotates about the second axis (the Y-axis).

When the center of magnetic attraction formed by the pulling magnet 2350 and the pulling yoke 1160 is constantly located within the support region T defined by the second ball member 2420 during the rotation of the carrier 2300, the carrier 2300 may rotate stably.

In an embodiment, the pulling magnet 2350 may be disposed such that the geometric center CP of the pulling magnet 2350 is spaced apart from the pivot ball 2421 approximately in the optical axis direction (the Z-axis direction). Accordingly, the center of rotation of the carrier 2300 and the center of magnetic attraction that presses the carrier 2300 against the housing 1100 may be located approximately on the optical axis (the Z-axis).

Additionally, referring again to FIG. 13, the pulling magnet 2350 may be disposed relatively closer to the pivot ball 2421 than the guide ball 2422 among the second ball members 2420 defining the support region T. For example, a distance between the geometric center CP of the pulling magnet 2350 and the pivot ball 2421 may be shorter than a distance between the geometric center CP of the pulling magnet 2350 and the guide ball 2422.

The shape of the support region T defined by the second ball member 2420 (2421 and 2422), while the carrier 2300 rotates, may change. For example, since the guide ball 2422 supports the rotation of the carrier 2300 while rolling inside the guide recesses 2323 and 1123, the position of the guide ball 2422 may change inside the guide recesses 2323 and 1123. In an example, the pivot ball 2421 may form a rotational axis of the carrier 2300, while rotating in place, while being accommodated in the accommodating recesses 2322 and 1122.

Therefore, when the pulling magnet 2350 is disposed close to the pivot ball 2421, although the shape of the support region T continuously changes according to the rotation of the carrier 2300, the probability of the pulling magnet 2350 being located within the support region T defined by the second ball member 2420 may increase. Therefore, the rotation of the carrier 2300 may be supported more stably.

The reflective module 2000 may include a second driving unit that provides a driving force to rotate the carrier 2300.

The second driving unit may include a second driving magnet 2331 and a second driving coil 2332 arranged to face each other. The carrier 2300 may be rotated about the second axis (the Y-axis) based on the electromagnetic interaction of the second driving magnet 2331 and the second driving coil 2332.

In an embodiment, the second driving magnet 2331 may be disposed in the carrier 2300, and the second driving coil 2332 may be disposed in the housing 1100. However, this is only an example, and in another embodiment, the positions of the second driving magnet 2331 and the second driving coil 2332 may be interchanged.

The second driving magnet 2331 may be disposed on the side surface of the carrier 2300. For example, the second driving magnet 2331 may include two magnets, which may be arranged on opposing sides of the carrier 2300, respectively.

According to an embodiment, the second driving magnet 2331 may be disposed on different sides of the second ball member 2420 and the carrier 2300. Accordingly, the sizes of the second driving magnet 2331 and the second driving coil 2332 may be increased, and since a distance from the rotation center to the driving center may be increased, driving force and driving efficiency may be improved.

In an example, the second driving coil 2332 may be mounted on the main substrate 5000 and disposed in the housing 1100. In an example, the second driving coil 2332 may include two coils in a one-to-one correspondence with a second driving magnet 2331, and they may be arranged on opposing sides of the housing 1100 respectively facing opposing sides of the carrier 2300. The second driving coil 2332 may be exposed to the internal space of the housing 1100 through a through-hole 1103 formed in the housing 1100, and thus may directly face the second driving magnet 2331.

In an embodiment, the second driving magnet 2331 and the second driving coil 2332 may face each other in the first axis direction (the X-axis direction).

The second driving magnet 2331 may be magnetized in the optical axis direction (the Z-axis direction), approximately the rotational direction of the carrier 2300. In an example, one surface of the second driving magnet 2331 facing the second driving coil 2332 may include an N-pole (S-pole) region, a neutral region, and an S-pole (N-pole) region in the optical axis direction (the Z-axis direction).

The second driving unit may include a second position sensing unit (or sensor) that detects the position of the carrier 3300. The second position sensing unit may include a second sensing magnet 2335 and a second position sensor 2333 arranged to face each other. In a non-limiting example, the second position sensor 2333 may be provided as a Hall sensor, and may detect a change in magnetic flux to detect the amount of movement of the carrier 2300.

The second sensing magnet 2335 may be disposed on one or opposing sides of the carrier 2330 together with the second driving magnet 2331. The second sensing magnet 2335 may be spaced apart from the second driving magnet 2331 in the optical axis direction (the Z-axis direction).

Additionally, one surface of the second sensing magnet 2335 facing the second position sensor 2333 may include an N-pole (S-pole) region, a neutral region, and an S-pole (N-pole) region in the optical axis direction (the Z-axis direction).

In an embodiment, the second driving magnet 2331 and the second sensing magnet 2335 may be arranged so that the same polarity regions (N-pole and N-pole or S-pole and S-pole) are adjacent to each other.

The second position sensor 2333 may be disposed on the main substrate 5000. The second position sensor 2333 may be disposed to face the neutral region of the second sensing magnet 2335 when the carrier 2300 is in the neutral position.

According to an embodiment, the second position sensor 2333 may be positioned apart from the first driving coil 2332, and thus, the second position sensor 233 may be less affected by the magnetic field of the first driving coil 2332, thereby improving the sensing accuracy.

The reflective module 2000 may include an auxiliary member 2500 that prevents a collision between the reflective module 2000 and an adjacent structure.

The auxiliary member 2500 may be coupled to opposing sides of the carrier 2300 to surround a portion of the reflective holder 2200. Accordingly, even if an impact occurs, the reflective holder 2200 and the carrier 2300 may be prevented from being separated.

The auxiliary member 2500 may include a damper. The damper may collide with a counterpart before an injection molded product, thereby absorbing impact and noise due to the collision.

Additionally, in accordance with one or more embodiments, a buffer member 1500 may be disposed between the housing 1100 and the carrier 2300.

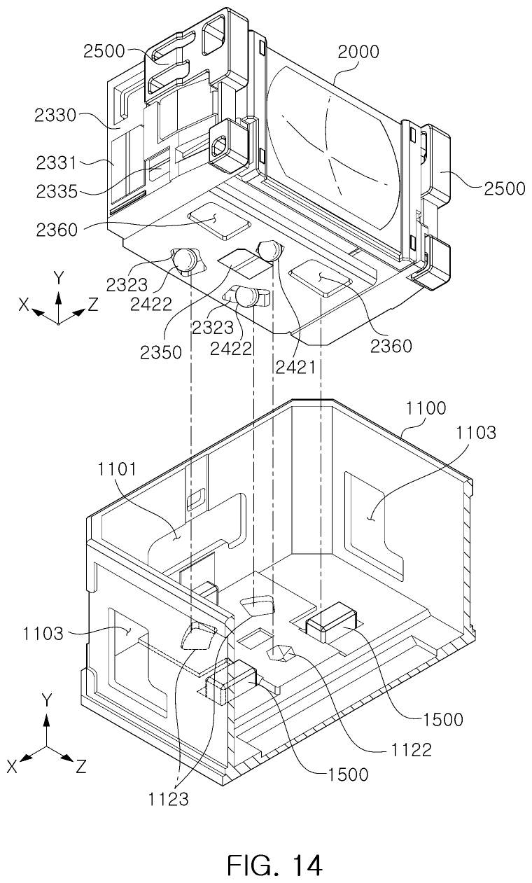

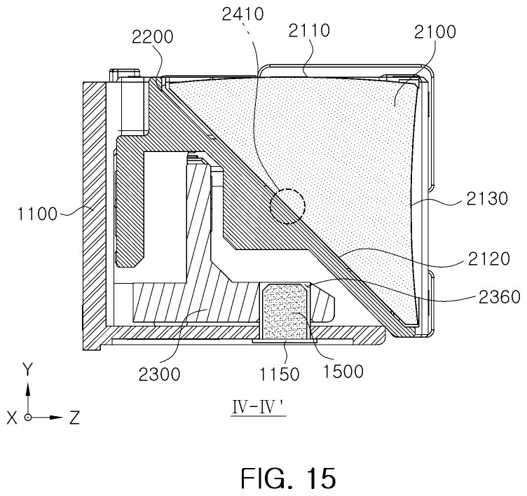

FIG. 14 is an exploded perspective view of the housing and the carrier, in accordance with one or more embodiments, and FIG. 15 is a cross-sectional view taken along line IV-IV′ of FIG. 9.

The buffer member 1500 may protrude from the bottom surface of the housing 1100 toward the bottom surface of the carrier 2300 facing the bottom surface of the housing 1100. That is, the buffer member 1500 may protrude in the second axis direction (the Y-axis direction) which is the thickness direction of the camera module 100.

In an embodiment, the buffer member 1500 may be a portion of the housing 1100. In an example, the buffer member 1500 may be formed integrally with the housing 1100 through insert-injection molding. Referring to FIG. 15, a steel support frame 1150 may be inserted into the bottom surface of the housing 1100, and the buffer member 1500 may be attached to the steel support frame 1150 and disposed in the housing 1100.

The buffer member 1500 may serve to absorb shock and noise caused by driving or collision. The buffer member 1500 may be formed of a soft material that is elastically deformable and may include, for example, materials, such as urethane, rubber, silicone, and sponge, as only examples.

Referring again to FIG. 14, the buffer member 1500 may be disposed in an accommodating portion 2360 provided on the bottom surface of the carrier 2300. The buffer member 1500 may be disposed in the accommodating portion 2360 with a small gap from the inner surfaces defining the accommodating portion 2360.

The buffer member 1500 may be spaced apart in the first axis direction (the X-axis direction) from the rotational axis (or the pivot ball 2421) of the carrier 2300 interposed therebetween.

The buffer member 1500 may have the operation of a stopper that limits the maximum rotation amount of the carrier 2300 with respect to the housing 1100.

The buffer member 1500 may be spaced apart from the inner surfaces defining the accommodating portion 2360 in the optical axis direction (the Z-axis direction). When the carrier 2300 is rotated about the second axis (the Y-axis), the buffer member 1500 may be deformed, while coming into contact with some of the inner surfaces facing in the optical axis direction (the Z-axis direction). Accordingly, the rotation range of the carrier 2300 may be limited, and collision and noise due to the rotation of the carrier 2300 may be alleviated.

Additionally, the buffer member 1500 may have a gap between the bottom surface of the accommodating portion 2360 and the second-axis direction (the Y-axis direction). In an example, the gap between the buffer member 1500 and the accommodating portion 2360 in the second-axis direction (the Y-axis direction) may be narrower than a gap between the carrier 2300 and the housing 1100 in the second-axis direction (the Y-axis direction). Therefore, when an impact is applied to the camera module 100 in the second-axis direction (the Y-axis direction), the carrier 2300 may first collide with the buffer member 1500, and direct collision with the housing 1100 may be prevented.

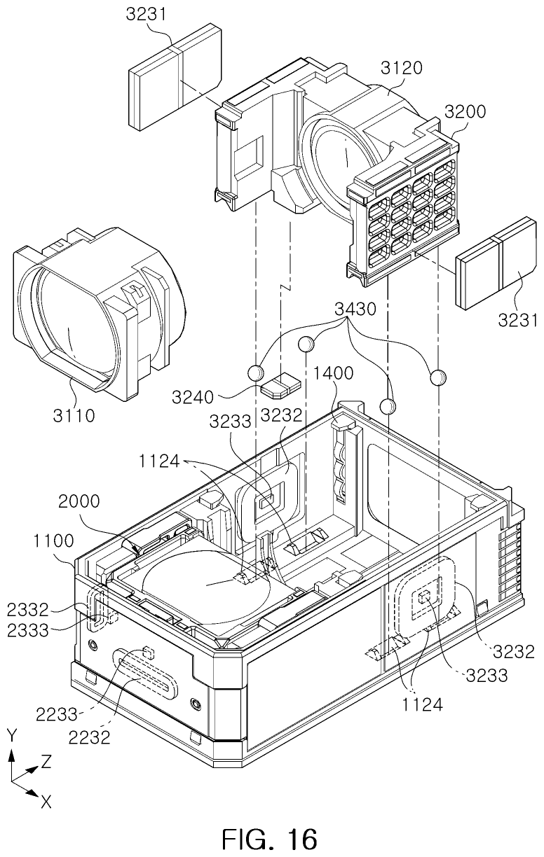

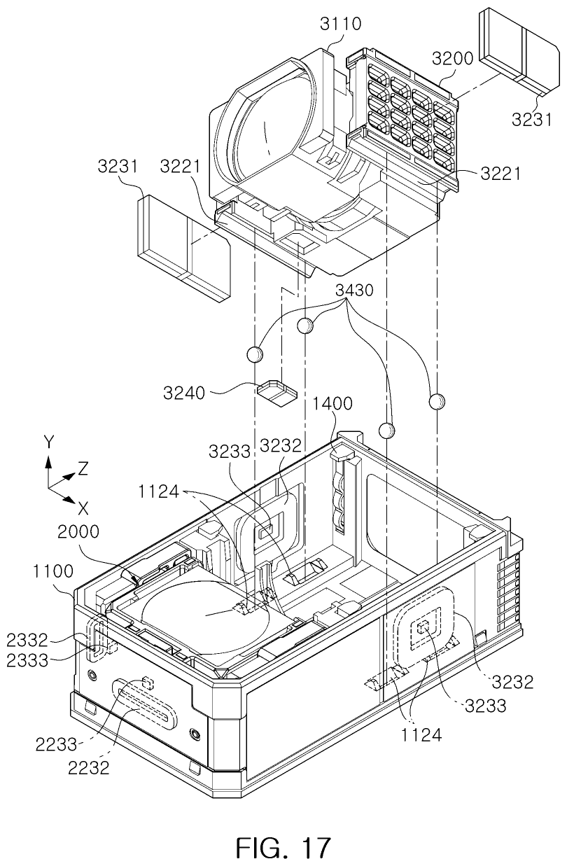

FIG. 16 is an exploded perspective view of the lens module, in accordance with one or more embodiments, and FIG. 17 is a bottom exploded perspective view of the lens module, in accordance with one or more embodiments.

Referring to FIGS. 16 and 17, the lens module 3000 may include a plurality of lens barrels 3110 and 3120 and a lens holder 3200 in which one of the plurality of lens barrels 3110 and 3120 is disposed. The lens holder 3200 may be movably disposed in the internal space of the housing 1100.

The plurality of lens barrels 3110 and 3120 may each include one or more lenses arranged or disposed in the optical axis direction (the Z-axis direction).

In an embodiment, the plurality of lens barrels 3110 and 3120 may include a first lens barrel 3110 fixedly disposed in the internal space of the housing 1100, and a second lens barrel 3120 disposed to be relatively movable with respect to the housing 1100.

The second lens barrel 3120 may be coupled to the lens holder 3200 and may be moved in the optical axis direction (the Z-axis direction) together with the lens holder 3200 with respect to the housing 1100 and the first lens barrel 3110.

The lens holder 3200 may include two side surfaces that are disposed parallel to each other. The two side surfaces of the lens holder 3200 may extend from opposing sides of the second lens barrel 3120 in the optical axis direction (the Z-axis direction). In an example, the two side surfaces of the lens holder 3200 may extend between the first lens barrel 3110 and the housing 1100, and a portion of the first lens barrel 3110 may be positioned between the two side surfaces of the lens holder 3200.

A third ball member 3430 may be positioned between the lens holder 3200 and the housing 1100 to support movement of the lens holder 3200 relative to the housing 1100. In an example, the third ball member 3430 may be positioned between the two sides of the lens holder 3200 and the housing 1100.

In an embodiment, the third ball member 3430 may include a plurality of ball members that support a first side and a second side of the lens holder 3200, which are arranged on the opposite sides of the second lens barrel 3120 based on the optical axis (the Z-axis). In an example, a first side and a second side of the lens holder 3200 may be supported by a plurality of ball members that are spaced apart from each other in the optical axis direction (the Z-axis direction). As another example, a first side of the lens holder 3200 may be supported by a plurality of ball members, and a second side of the lens holder 3200 may be supported by a single ball member.

Referring to FIG. 17, the lens holder 3200 and the housing 1100 may include guide recesses 3221 and 1124 that accommodate a third ball member 3430.

A third guide recess 3221 having a length in the optical axis direction (the Z-axis direction) may be provided on a first side and a second side of the lens holder 3200. In an example, the third guide recess 4127 may be provided on the bottom surface of two side surfaces of the lens holder 3200. A fourth guide recess 1124 having a length in the optical axis direction (the Z-axis direction) may be disposed in the housing 1100. The fourth guide recess 1124 may face the third guide recess 3221 with the third ball member 3430 in between.

The third ball member 3430 may support movement of the lens holder 3200, while rollingly moving in the optical axis direction (the Z-axis direction), while being inserted between the third guide recess 3221 and the fourth guide recess 1124.

The lens holder 3200 may be supported by the housing 1100 by a magnetic force (magnetic attraction). Accordingly, a pair of magnetic members, which generate a magnetic attraction may be arranged in the lens holder 3200 and the housing 1100.

The pair of magnetic members may include a pulling magnet 3240 disposed in the lens holder 3200 and a pulling yoke (not shown) disposed in the housing 1100.

The pair of magnetic members may generate a magnetic attraction in a direction facing each other. In an example, the pair of magnetic members may face each other in the second-axis direction (the Y-axis direction), and the magnetic attraction therebetween may be generated in the second-axis direction (the Y-axis direction). Accordingly, the lens holder 3200 may be supported in the housing 1100 in the second-axis direction (the Y-axis direction).

In an example, the direction in which the lens holder 3200 is supported on the housing 1100 may coincide with the direction in which the lens holder 3200 and the housing 1100 face each other with the third ball member 3430 in between. Therefore, the third ball member 3430 may not escape from between the lens holder 3200 and the housing and may support the movement of the lens holder 3200.

The lens module 3000 may include a third driving unit that provides a driving force to move the lens holder 3200.

The third driving unit may include a third driving magnet 3231 and a third driving coil 3232 arranged to face each other. The lens holder 3200 may be moved in the optical axis direction (the Z-axis direction) based on the electromagnetic interaction between the third driving magnet 3231 and the third driving coil 3232.

In an embodiment, the third driving magnet 3231 may be disposed in the lens holder 3200, and the third driving coil 3232 may be disposed in the housing 1100. However, in another embodiment, the positions of the third driving magnet 3231 and the third driving coil 3232 may be interchanged.

The third driving magnet 3231 may be disposed on a side surface of the lens holder 3200. In an example, the third driving magnet 3231 may include two magnets, which may be disposed on two sides of the lens holder 3200, respectively.

The third driving coil 3232 may be mounted on the main substrate 5000 and may be disposed in the housing 1100. In an example, the third driving coil 3232 may include two coils in a one-to-one correspondence with the third driving magnet 3231, which may be disposed on opposing sides of the housing facing opposing sides of the lens holder 3200, respectively. The third driving coil 3232 may be exposed to the internal space of the housing 1100 through the through-hole 1105 formed in the housing 1100, and thus may directly face the third driving magnet 3231.

In an embodiment, the third driving magnet 3231 and the third driving coil 3232 may face each other in the first axis direction (the X-axis direction).

The third driving magnet 3231 may be magnetized in the optical axis direction (the Z-axis direction), which is the moving direction of the lens holder 3200. In an example, one surface of the third driving magnet 3231 facing the third driving coil 3232 may be provided with an N-pole (S-pole) region, a neutral region, and an S-pole (N-pole) region in the optical axis direction (the Z-axis direction).

The third driving unit may include a third position sensor 3233 detecting the position of the lens holder 3200. In an example, the third position sensor 3233 may be provided as a Hall sensor, and may detect a change in magnetic flux to detect the amount of movement of the lens holder 3200.

The third position sensor 3233 may be disposed on the main substrate 5000 and may be disposed on the inside or outside of the third driving coil 3232. The third position sensor 3233 may be disposed to face the neutral region of the third driving magnet 3231 when the lens holder 3200 is in the neutral position.

The housing 1100 may include at least a pair of stoppers 1400 that face each other in the optical axis direction (the Z-axis direction) with the lens module 3000 in between. For example, the stoppers 1400 may be provided to be fitted into the wall of the housing 1100.

The stopper 1400 may include a damper that protrudes toward the lens module 3000. The damper may be provided to face the lens holder 3200 in the optical axis direction (the Z-axis direction) to prevent a direct collision between the lens holder 3200 and the housing 1100. In an example, the damper provided in the stopper 1400 may collide with the lens holder 3200 before an injection molded product when the lens holder 3200 has been moved to the maximum, thereby absorbing shock and noise due to the collision.

According to the one or more embodiments, the driving stability of the reflective module and the optical image stabilization performance of the camera module may be improved.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A reflective module, comprising:
a housing;
a reflective member configured to rotate about a first axis in the housing;
a driving unit configured to rotate the reflective member based on the first axis; and
a pair of magnetic members disposed to face each other in a direction between the housing and the reflective member,
wherein the driving unit comprises a driving magnet and a driving coil that face each other in a direction, different from the direction in which the pair of magnetic members face each other, and
wherein the first axis passes through the reflective member.

2. The reflective module of claim 1, wherein the pair of magnetic members face each other in a direction, parallel to the first axis, and the driving magnet and the driving coil face each other in a second axis direction, perpendicular to the first axis.

3. The reflective module of claim 1, further comprising:
a reflective holder on which the reflective member is disposed; and
a carrier on which the reflective holder is supported;
wherein the carrier configured to rotate about the first axis together with the reflective member and the reflective holder, while being disposed in the housing.

4. The reflective module of claim 3, wherein the driving magnet and one of the pair of magnetic members are respectively disposed on different sides of the carrier.

5. The reflective module of claim 4, further comprising:
a sensing magnet disposed in the carrier in parallel with the driving magnet; and
a position sensor disposed in the housing to face the sensing magnet.

6. The reflective module of claim 4, wherein:
a plurality of ball members are disposed between the housing and the carrier,
the plurality of ball members comprise a pivot ball through which the first axis passes and a plurality of guide balls that are spaced apart from the pivot ball, and
a shortest distance between the pivot ball and the guide ball is less than a shortest distance between the pivot ball and the driving magnet.

7. The reflective module of claim 6, wherein the plurality of guide balls comprise two ball members, and an angle between the two ball members based on the pivot ball is an acute angle.

8. The reflective module of claim 6, wherein the magnetic member disposed on the carrier, among the pair of magnetic members, is disposed inside a support region that is formed by connecting the plurality of ball members.

9. The reflective module of claim 3, wherein the reflective holder is rotated based on a second axis, perpendicular to the first axis, together with the reflective member.

10. The reflective module of claim 3, wherein:
a buffer member is disposed to protrude in a direction, parallel to the first axis, toward the carrier in the housing, and the buffer member is spaced apart from a pivot ball of a plurality of ball members in a direction of a second axis, perpendicular to the first axis, with the first axis interposed therebetween.

11. A reflective module, comprising:
a housing having an internal space;
a reflective member disposed in the internal space;
a carrier rotatably supported in the internal space; and
three ball members disposed between the housing and the carrier, and configured to support a rotation of the carrier,
wherein a triangle formed by connecting the three ball members is an acute triangle.

12. The reflective module of claim 11, further comprising:
a pair of magnetic members respectively disposed on a surface of the housing and a surface of the carrier which face each other with the three ball members interposed therebetween, and the pair of magnetic members are configured to generate a magnetic attraction,
wherein the pair of magnetic members are disposed so that a center of a magnetic attraction formed by the pair of magnetic members is located within the acute triangle.

13. The reflective module of claim 12, wherein:
the pair of magnetic members comprise:
a pulling magnet disposed on the carrier; and
a pulling yoke disposed in the housing to face the pulling magnet.

14. The reflective module of claim 13, wherein:
the three ball members comprise:
a pivot ball through which a rotational axis of the carrier passes; and
two guide balls spaced apart from the pivot ball,
wherein the pulling magnet is disposed in a position at which a distance between a center of the pulling magnet and the pivot ball is less than a distance between the center of the pulling magnet and the two guide balls.

15. The reflective module of claim 14, wherein the center of the pulling magnet is spaced apart from the pivot ball in a direction perpendicular to the rotational axis of the carrier.

16. A camera module, comprising:
the reflective module according to claim 1; and
a lens module comprising a plurality of lenses configured to refract light passing through the reflective module.

17. A reflective module, comprising:
a housing having an internal space;
a carrier disposed within the internal space;
a reflective holder disposed on the carrier, and
a reflective member mounted on the reflective holder,
wherein the housing comprises a buffer member that protrudes toward the carrier, and
wherein the carrier comprises an accommodating portion configured to accommodate the buffer member.

18. The reflective module of claim 17, wherein the carrier is rotated about a first axis with respect to the housing, and the reflective holder is rotated about a second axis, perpendicular to the first axis, with respect to the carrier and the housing.

19. The reflective module of claim 18, further comprising a pivot ball through which the first axis passes and a plurality of guide balls spaced apart from the pivot ball,
wherein the pivot ball and the plurality of guide balls are arranged between the carrier and the housing.

20. The reflective module of claim 19, wherein the buffer member is provided in plural, and the plurality of buffer members are spaced apart from each other with the pivot ball disposed therebetween.

21. The reflective module of claim 20, wherein the pivot ball and the plurality of buffer members are arranged in a direction parallel to the second axis.

22. The reflective module of claim 18, wherein the buffer member is spaced apart from the reflective holder in a direction parallel to the first axis.

23. The reflective module of claim 17, further comprising a support frame that is at least partially disposed inside the housing,
wherein the buffer member is disposed on the support frame.

24. The reflective module of claim 19, further comprising:
a first driving unit comprising a first driving magnet and a first driving coil and configured to generate a driving force to rotate the carrier about the first axis; and
a pair of magnetic members respectively disposed on the carrier and the housing and configured to generate a magnetic force to press the carrier against the housing,
wherein a direction in which the first driving magnet and the first driving coil face each other, and a direction in which the pair of magnetic members face each other are perpendicular to each other.

25. The reflective module of claim 24, wherein the first driving magnet and the first driving coil face each other in a direction parallel to the second axis, and the pair of magnetic members face each other in a direction parallel to the first axis.

26. A camera module, comprising:
the reflective module according to claim 17; and
a lens module comprising a plurality of lenses configured to refract light passing through the reflective module.
